(19) United States
(12) Patent Application Publication
(10) Pub. No.: US 2006/0046197 A1
(43) Pub. Date: Mar. 2, 2006

(54) Device and method of fabricating donor substrate for laser induced thermal imaging and method of fabricating OELD device using the same

(76) Inventors: Mu-Hyun Kim, Suwon-si (KR); Myung-Won Song, Suwon-si (KR); Byung-Doo Chin, Seongnam-si (KR); Seong-Taek Lee, Suwon-si (KR)

Correspondence Address: MCGUIREWOODS, LLP, 1750 TYSONS BLVD, SUITE 1800, MCLEAN, VA, 22102, US

(21) Appl. No.: 11/020,673

(22) Filed: Dec. 27, 2004

(30) Foreign Application Priority Data
Sep. 2, 2004 (KR) 2004-70083

(51) Int. Cl. G03C 1/492

(52) U.S. Cl. 430/273.1; 430/200

(57) ABSTRACT

A device of fabricating a donor substrate for a LITI includes a vacuum chamber; a donor substrate which moves in line and passes through an inside of the vacuum chamber; and a depositing device arranged in the vacuum chamber and forming a transfer layer on the donor substrate.

### CROSS-REFERENCE TO RELATED APPLICATION

This application claims the benefit of Korean Patent Application No. 2004-70083, filed Sep. 2, 2004, the disclosure of which is hereby incorporated herein by reference in its entirety.

### BACKGROUND OF THE INVENTION

1. Field of the Invention

The present invention relates to a device and method of fabricating a donor substrate for a laser induced thermal image and method of fabricating an OELD device using the same and, more particularly, to a device and method which form a transfer layer on a donor substrate for a laser induced thermal imaging when forming an organic layer pattern using the laser induced thermal imaging and method of fabricating an OELD device using the same.

2. Description of the Related Art

An OELD device which is one of flat panel display devices includes an anode electrode and a cathode electrode with organic layers interposed therebetween.

The organic layer includes at least a light emitting layer and may further include a hole injecting layer, a hole transporting layer, an electron transporting layer, and an electron injecting layer. The OELD device is classified into a polymer OELD device and a monomer OELD device according to a material and process of forming the organic layer, particularly the light emitting layer.

The light emitting layer should be patterned for implementing a full color of the OELD device. The method of patterning the light emitting layer includes an ink jet printing technique and a laser induced thermal imaging (“LITI”) technique in case of the polymer OELD device. The LITI technique can pattern finely the organic layer and can be employed for a large size device and can achieve high resolution. The LITI technique also has an advantage in that it is a dry process while the ink jet printing is a wet process.

The method of forming the organic layer using the LITI requires at least a light source, an OELD device substrate and a donor substrate. The organic layer is patterned such that light emitted from the light source is absorbed into a light-heat converting layer to be converted to heat energy and a material of a transfer layer is transferred to the substrate due to the heat energy. This is disclosed in Korea Patent Application No. 1998-51844 and U.S. Pat. Nos. 5,998,085, 6,214,520, and 6,114,088.

In case of the monomer OELD device, a shadow mask may be used for patterning the light emitting layer. However, the method of patterning a monomer layer has disadvantages in that it is difficult to fabricate a large size OELD device and a material is limited because the is ink jet printing is a wet process.

### SUMMARY OF THE INVENTION

It is an object of the present invention to provide a device and method of fabricating a donor substrate for a LITI which can form a transfer layer made of a monomer material on a donor substrate for a LITI by sequentially forming a transfer layer in a vacuum chamber, and is suitable for mass production and a large size OELD device, and method of fabricating the OELD device using the same.

In one aspect of the present invention, a device of fabricating a donor substrate for a LITI includes a vacuum chamber; a donor substrate which moves in line and passes through an inside of the vacuum chamber; and a depositing device arranged in the vacuum chamber and forming a transfer layer on the donor substrate.

The device further includes a thickness measuring means arranged in the vacuum chamber and measuring thickness of the transfer layer formed by the depositing device; and a thickness control means arranged outside the vacuum chamber to be connected to the thickness measuring means and receiving information from the thickness measuring means to control thickness of the transfer layer formed by the depositing device.

In another aspect of the present invention, a method of fabricating a donor substrate for a LITi, includes: passing a donor substrate in line through a vacuum chamber; and a depositing device, arranged in the vacuum chamber, forming a transfer layer on the donor substrate.

In other aspect of the present invention, a method of fabricating an OELD device, includes: preparing a substrate having a pixel electrode formed thereon; laminating the donor substrate having the transfer layer fabricated by the method of fabricating the donor substrate for the LITI onto a front surface of the substrate; and irradiating a laser to a predetermined region of the donor substrate to form an organic layer pattern on the pixel electrode.

The method further includes a thickness measuring means measuring thickness of the transfer layer formed by the depositing device; and a thickness control means receiving information from the thickness measuring means to control thickness of the transfer layer formed by the depositing device.

The vacuum chamber has at least three vacuum chambers which are coupled in series, and the depositing device is arranged in the vacuum chamber which is located in the middle among the three vacuum chambers.

The depositing device is a resistance heated type.

The transfer layer formed on the donor substrate is made of a monomer organic material, particularly, a monomer organic light emitting material.

The depositing device is fixed in the vacuum chamber, and the transfer layer is formed on the donor substrate which continuously moves.

The depositing device is fixed in the vacuum chamber, and the donor substrate stops to form the transfer layer and then moves forward to pass through the vacuum chamber.

The depositing device performs a reciprocating motion in the vacuum chamber, and the transfer layer is formed on the donor substrate which continuously moves.

The depositing device performs a reciprocating motion in the vacuum chamber, and the donor substrate stops to form the transfer layer and then moves forward to pass through the vacuum chamber.

The donor substrate is a flexible donor substrate.

The flexible donor substrate is made of plastic. The flexible donor substrate is made of a material selected from a group comprised of polyethylene terephthalate (PET), polyethylenenaphthalate (PEN), polyether sulfone (PES), polybutylene terepthatlate (PBT), polycarbonate (PC), polystyrene Paper (PSP), and polyetheretherketone (PEEK).

The flexible donor substrate is made of metal such as steel use stainless (SUS) or aluminum (Al).

The flexible donor substrate is less than 500□ in thickness and is less than 50×10⁻⁶/° C. in thermal expansion coefficient.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a view illustrating a device and process of fabricating a donor substrate for a LITI according a first embodiment of the present invention;

FIG. 2 is a view illustrating a device and process of fabricating a donor substrate for a LITI according a second embodiment of the present invention;

FIG. 3 is a view illustrating a device and process of fabricating a donor substrate for a LITI according a third embodiment of the present invention;

FIG. 4 is a view illustrating a device and process of fabricating a donor substrate for a LITI according a fourth embodiment of the present invention; and

FIGS. 5a to 5c are cross-sectional views illustrating a method of fabricating an OELD device according to the present invention.

### DETAILED DESCRIPTION OF THE INVENTION

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the thickness of layers and regions are exaggerated for clarity. Like numbers refer to like elements throughout the specification.

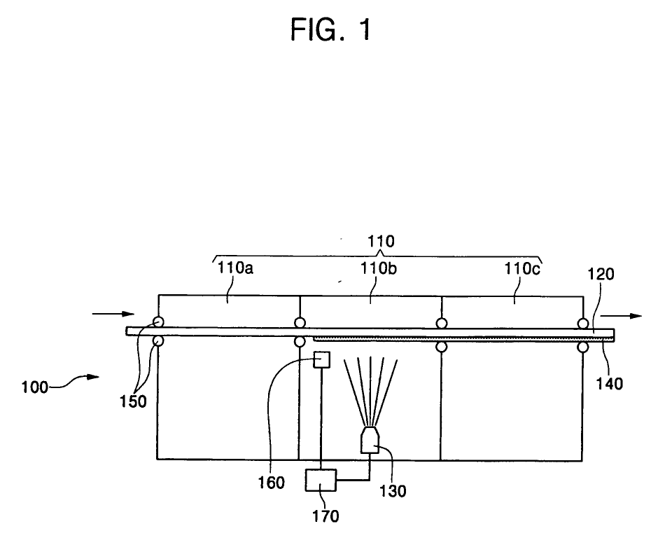

FIG. 1 is a view illustrating a device and process of fabricating a donor substrate for a LITI according a first embodiment of the present invention.

Referring to FIG. 1, a device 100 of fabricating the donor substrate for the LITI includes a vacuum chamber 110 having a first vacuum chamber 110a, a second vacuum chamber 110b, and a third vacuum chamber 110c which are connected in series, a donor substrate 120, a deposition device 130, a donor substrate feed roller 150, a thickness measuring means 160, and a thickness control means 170.

The vacuum chamber 110 includes at least three vacuum chambers which are connected in series to maintain high vacuum. A pump (not shown) is used for the high vacuum, and the high vacuum can be maintained by discharging air in the vacuum chamber. When a transfer layer is formed by the depositing device which will be described below, the high vacuum is required to prevent deposition of impurities, and the transfer layer is preferably formed in the high vacuum of less than 10⁻⁴ torr.

The donor substrate 120 passes through an inside of the vacuum chamber 110 while moving in line. This embodiment exemplarily shows that the donor substrate 120 passes through an inside upper portion of the vacuum chamber 110. The donor substrate 120 moves and passes through the inside of the vacuum chamber 110 by the donor substrate feed roller 150. The donor substrate 120 may move without stop or may stop to form a transfer layer 140 and then moves to pass through the vacuum chamber 110.

The donor substrate 120 may be made of a flexible material. For example, the donor substrate 120 may be made of flexible plastic or flexible metal.

The flexible plastic may be a material selected from a group comprised of polyethylene terephthalate (PET), polyethylenenaphthalate (PEN), polyether sulfone (PES), polybutylene terepthatlate (PBT), polycarbonate (PC), polystyrene Paper (PSP), polyetheretherketone (PEEK), acrylic resin, metacrylic resin, polyetherimide (PEI), and polyimide. Preferably, the flexible plastic is made of polyethylene terephthalate (PET).

The flexible metal may be steel use stainless (SUS) or aluminum (Al).

The flexible donor substrate 120 preferably has a thermal expansion coefficient of less than 50×10⁻⁶/° C. If the thermal expansion coefficient of the donor substrate 120 exceeds 50×10⁻⁶/° C., the donor substrate 120 may be easily expanded in volume due to heat, and thus it becomes difficult to form the transfer layer.

The depositing device 130 is arranged in the vacuum chamber. This embodiment exemplarily shows that the depositing device 130 is arranged in the second vacuum chamber 110b. The depositing device 130 is fixed at a lower portion of the second vacuum chamber 110b, that is, below the donor substrate 120.

The depositing device 130 serves to form the transfer layer 140 on the donor substrate 120. Here, the depositing device 130 may be a resistance Heated type. The transfer layer 140 formed on the donor substrate 120 may be made of a monomer organic material and particularly made of an organic light emitting material.

The thickness measuring means 160 is arranged in the second vacuum chamber 110b and serves to measure thickness of the transfer layer 140 formed by the depositing device 130. A crystal oscillator may be used as the thickness measuring means 160, and thickness of the transfer layer 140 is measured by frequency variation.

The thickness control means 170 is arranged outside the vacuum chamber 110 and is connected to the thickness measuring means 160 and the depositing device 130. That is, information measured by the thickness measuring means 160 is transmitted to the thickness control means 170, and the thickness control means 170 controls the depositing device 130 to control thickness of the transfer layer 140 using the measured information.

The transfer layer 140 is formed on the donor substrate 120 by the device of fabricating the donor substrate for the LITI according to the first embodiment of the present invention.

In detail, the donor substrate 120 continuously moves in the vacuum chamber 110. Here, the transfer layer 140 is formed on the donor substrate 120 by the depositing device 130 arranged below the donor substrate 120. That is, a deposition material contained in the depositing device 130 is heated at a temperature of 250° C. by the depositing device 130 and thus is converted to vapors which are deposited on the donor substrate 120 to form the transfer layer 140. Here, deposition is preferably performed at a speed of 1 Å/s.

Thickness of the deposited material is measured by the thickness measuring means 160, and measured thickness information is transmitted to the thickness control means 170. According to the measured information, the thickness control means 170 controls the depositing device 130 to control thickness of the transfer layer.

The donor substrate 120 may move in a step method. That is, the donor substrate 120 may stop its movement in the vacuum chamber 110, i.e., the second vacuum chamber. At this time, the depositing device 130 forms the transfer layer 140 on the donor substrate 120. Thereafter, the donor substrate 120 move forward, and when a portion of the donor substrate 120 has no transfer layer 140 reaches the second vacuum chamber 110b, the donor substrate 120 stops to form the transfer layer 140. The above-described process is repeated to continuously deposit the transfer layer 140 on the donor substrate 120.

As described above, the first embodiment of the present invention shows that the transfer layer can be continuously formed on the donor substrate by using the depositing device fixed below the donor substrate which moves in the vacuum chamber of high vacuum. Therefore, the transfer layer, i.e., the monomer organic light emitting layer can be formed on the donor substrate, and since the continuous deposition is possible, the donor substrate can be mass-produced.

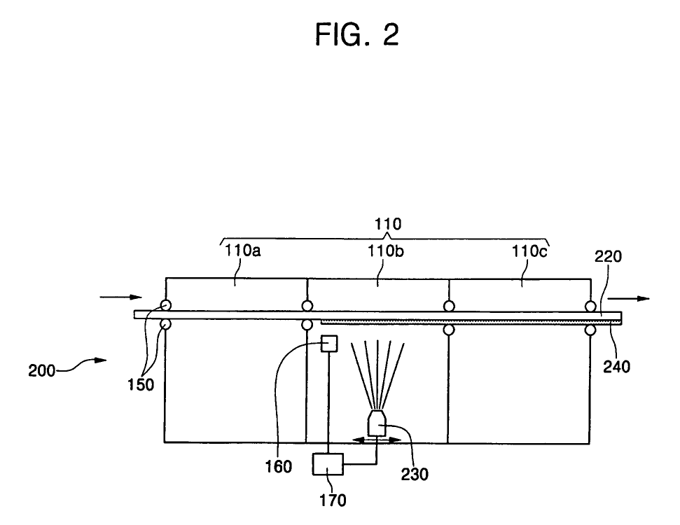

FIG. 2 is a view illustrating a device and process of fabricating a donor substrate for a LITI according a second embodiment of the present invention.

Referring to FIG. 2, a device 200 of fabricating the donor substrate for the LITI includes a vacuum chamber 110 having a first vacuum chamber 110a, a second vacuum chamber 110b, and a third vacuum chamber 110c which are coupled in series, a donor substrate 220 which passes through an inside upper portion of the vacuum chamber 110, a deposition device 230 located below the donor substrate 220, a donor substrate feed roller 150, a thickness measuring means 160, and a thickness control means 170. Unlike the first embodiment, the depositing device 230 is not fixed in the second vacuum chamber 110b and performs left and right reciprocating motion in the second vacuum chamber 110b.

The transfer layer 240 is formed on the donor substrate 220 which passes through the upper portion of the vacuum chamber 110 continuously or in a step method by using the depositing device 230 which repeatedly moves left and right in the second vacuum chamber

Except the above description, the device and process of fabricating the donor substrate for the LITI according the second embodiment is identical to those of the second embodiment.

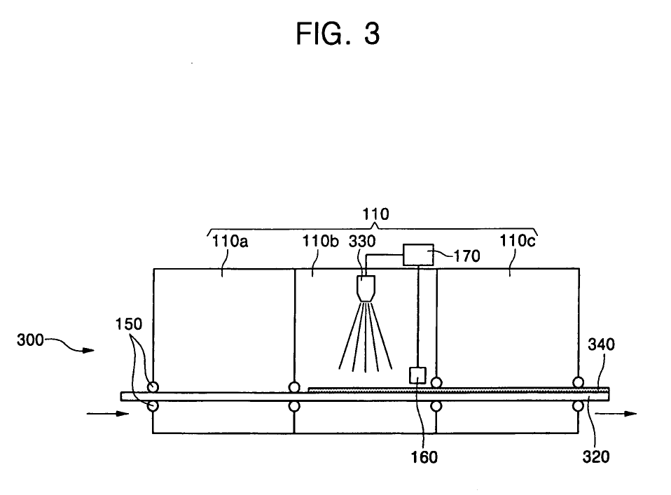

FIG. 3 is a view illustrating a device and process of fabricating a donor substrate for a LITI according a third embodiment of the present invention.

Referring to FIG. 3, a device 300 of fabricating the donor substrate for the LITI includes a vacuum chamber 110 having a first vacuum chamber 110a, a second vacuum chamber 110b, and a third vacuum chamber 110c which are coupled in series, a donor substrate 320 which passes through an inside lower portion of the vacuum chamber 110, a deposition device 330 located above the donor substrate 320, a donor substrate feed roller 150, a thickness measuring means 160, and a thickness control means 170. The transfer layer 340 is formed on the donor substrate 120 by using the depositing device 330 which is arranged above the donor substrate 320.

Except the above description, the device and process of fabricating the donor substrate for the LITI according the third embodiment is identical to those of the second embodiment.

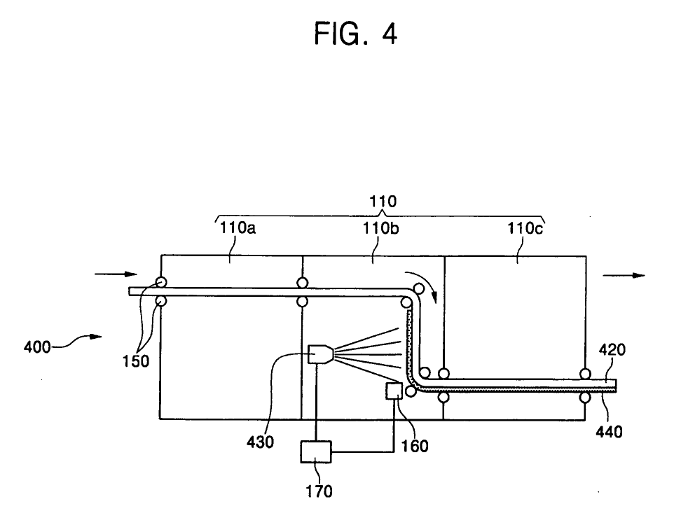

FIG. 4 is a view illustrating a device and process of fabricating a donor substrate for a LITI according a fourth embodiment of the present invention.

Referring to FIG. 4, a device 400 of fabricating the donor substrate for the LITI includes a vacuum chamber 110 having a first vacuum chamber 110a, a second vacuum chamber 110b, and a third vacuum chamber 110c which are coupled in series, a donor substrate 420 which passes through an inside of the vacuum chamber 110, a deposition device 430 located at a left side of the donor substrate 420, a donor substrate feed roller 150, a thickness measuring means 160, and a thickness control means 170.

The donor substrate 420 passes through the vacuum chamber 110 such that it moves along an upper portion in the first vacuum chamber, moves along an upper portion at first and later moves down a right side surface at a right side of the depositing device 430 in the second vacuum chamber 110b, and moves along a lower portion in the third vacuum chamber

The transfer layer 440 is formed on the donor substrate 420 which moves along a right side surface of the second vacuum chamber 110b by using the depositing device 430 which is arranged at a left side of the donor substrate 420.

The flexible donor substrate 420 preferably has thickness of less than 500 μm. If thickness of the donor substrate 420 exceeds 500 μm, the donor substrate is difficult to bend and thus it is difficult to move in the second vacuum chamber 110b.

Except the above description, the device and process of fabricating the donor substrate for the LITI according the fourth embodiment is identical to those of the second embodiment.

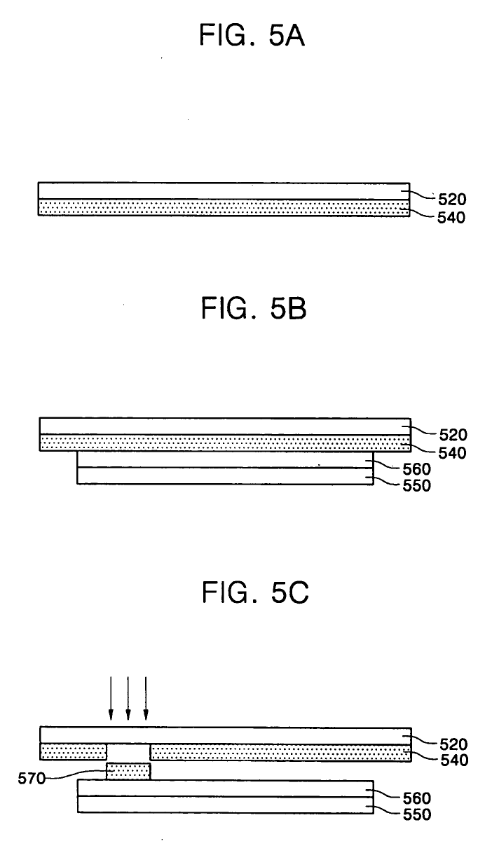

FIGS. 5a to 5c are cross-sectional views illustrating a method of fabricating an OELD device according to the present invention.

Referring to FIG. 5a, the transfer layer 540 is formed by using the device and method of fabricating the donor substrate for the LITI according to the first to fourth embodiments of the present invention. Here, the depositing device of the device and method of fabricating the donor substrate for the LITI contains a deposition material. The deposition material may be a monomer organic material and particularly may be a monomer organic light emitting material. Therefore, the monomer organic light emitting layer may be formed on the donor substrate 520.

Referring to FIG. 5b, the donor substrate 520 having the transfer layer 540 formed thereon is laminated with a substrate 550 having a predetermined element formed thereon. Here, as the predetermined element, a thin film transistor (TFT), a planarization layer formed on the TFT and a pixel electrode formed on the planarization layer may be arranged.

Referring to FIG. 5c, a laser is irradiated into the donor substrate 520 having the transfer layer 540 to form an organic layer pattern 570 on the pixel electrode 560.

A process of forming the organic layer pattern 570 may be performed at a N₂ atmosphere. The transfer process may be performed at a nitrogen atmosphere which does not have an oxygen element because the organic layer pattern 570 may be oxidized in a normal atmosphere. Also, the transfer process may be performed at a vacuum atmosphere, which has effect of suppressing air bubbles which may occur between the donor substrate and the substrate during the lamination process.

The organic layer pattern 570 may be a single layer or multiple layers selected a group comprised of a light emitting layer, a hole injecting layer, a hole transporting layer, an electron transporting layer, and an electron injecting layer. In particular, the organic layer pattern 570 may be a monomer organic light emitting layer.

After forming the organic layer pattern 570 on the pixel electrode 560, a cathode electrode is formed on the organic layer pattern 570, thereby completing the OELD device.

As described above, the large size OELD device can be fabricated using the donor substrate having the monomer transfer layer formed by the method of fabricating the donor substrate for the LITI.

As described herein before, the present invention has advantages in that the transfer layer, particularly the monomer organic light emitting layer, can be continuously formed in the vacuum chamber which maintains the high vacuum, and the donor substrate having the transfer layer can be mass-produced. Also, the large size OELD device can be fabricated using the donor substrate having the transfer layer.

What is claimed is:

1. A device of fabricating a donor substrate for a LITI, comprising:
a vacuum chamber;
a donor substrate which moves in line and passes through an inside of the vacuum chamber; and
a depositing device arranged in the vacuum chamber and forming a transfer layer on the donor substrate.

2. The device of claim 1, wherein the vacuum chamber has at least three vacuum chambers which are coupled in series.

3. The device of claim 1, wherein the vacuum chamber has at least three vacuum chambers which are coupled in series, and the depositing device is arranged in the vacuum chamber which is located in the middle among the three vacuum chambers.

4. The device of claim 1, wherein the depositing device is a resistance heated type.

5. The device of claim 1, further comprising,
a thickness measuring means arranged in the vacuum chamber and measuring thickness of the transfer layer formed by the depositing device; and
a thickness control means arranged outside the vacuum chamber to be connected to the thickness measuring means and receiving information from the thickness measuring means to control thickness of the transfer layer formed by the depositing device.

6. The device of claim 1, wherein the donor substrate is a flexible donor substrate.

7. The device of claim 6, wherein the flexible donor substrate is made of plastic.

8. The device of claim 7, wherein the flexible donor substrate is made of a material selected from a group comprised of polyethylene terephthalate (PET), polyethylenenaphthalate (PEN), polyether sulfone (PES), polybutylene terepthatlate (PBT), polycarbonate (PC), polystyrene Paper (PSP), and polyetheretherketone (PEEK).

9 The device of claim 6, wherein the flexible donor substrate is made of metal.

10. The device of claim 9, wherein the flexible donor substrate is steel use stainless (SUS) or aluminum (Al).

11. The device of claim 6, wherein thickness of the flexible donor substrate is less than 500 μm.

12. The device of claim 6, wherein thermal expansion coefficient of the flexible donor substrate is less than 50×10⁻⁶/° C.

13. A method of fabricating a donor substrate for a LITi, comprising:
passing a donor substrate in line through a vacuum chamber; and
a depositing device, arranged in the vacuum chamber, forming a transfer layer on the donor substrate.

14. The method of claim 13, wherein the vacuum chamber has at least three vacuum chambers which are coupled in series.

15. The method of claim 13, wherein the vacuum chamber has at least three vacuum chambers which are coupled in series, and the depositing device is arranged in the vacuum chamber which is located in the middle among the three vacuum chambers.

16. The method of claim 1, wherein the depositing device is a resistance heated type.

17. The method of claim 13, further comprising,
a thickness measuring means measuring thickness of the transfer layer formed by the depositing device; and
a thickness control means receiving information from the thickness measuring means to control thickness of the transfer layer formed by the depositing device.

18. The method of claim 13, wherein the depositing device is fixed in the vacuum chamber, and the transfer layer is formed on the donor substrate which continuously moves.

19. The method of claim 13, wherein the depositing device is fixed in the vacuum chamber, and the donor substrate stops to form the transfer layer and then moves forward to pass through the vacuum chamber.

20. The method of claim 13, wherein the depositing device performs a reciprocating motion in the vacuum chamber, and the transfer layer is formed on the donor substrate which continuously moves.

21. The method of claim 13, wherein the depositing device performs a reciprocating motion in the vacuum chamber, and the donor substrate stops to form the transfer layer and then moves forward to pass through the vacuum chamber.

22. The method of claim 13, wherein the donor substrate is a flexible donor substrate.

23. The method of claim 22, wherein the flexible donor substrate is made of plastic.

24. The method of claim 23, wherein the flexible donor substrate is made of a material selected from a group comprised of polyethylene terephthalate (PET), polyethylenenaphthalate (PEN), polyether sulfone (PES), polybutylene terepthatlate (PBT), polycarbonate (PC), polystyrene Paper (PSP), and polyetheretherketone (PEEK).

25. The method of claim 22, wherein the flexible donor substrate is made of metal.

26. The method of claim 25, wherein the flexible donor substrate is steel use stainless (SUS) or aluminum (Al).

27. The method of claim 22, wherein thickness of the flexible donor substrate is less than 500 μm.

28. The method of claim 22, wherein thermal expansion coefficient of the flexible donor substrate is less than 50×10⁻⁶/° C.

29. The method of claim 13, wherein the deposition process in the vacuum chamber is performed in vacuum of less than 10⁻⁴ torr.

30. A method of fabricating an OELD device, comprising:
preparing a substrate having a pixel electrode formed thereon;
laminating the donor substrate having the transfer layer fabricated by the method of claim 13 onto a front surface of the substrate; and
irradiating a laser to a predetermined region of the donor substrate to form an organic layer pattern on the pixel electrode.

31. The method of claim 30, wherein the vacuum chamber has at least three vacuum chambers which are coupled in series.

32. The method of claim 30, wherein the vacuum chamber has at least three vacuum chambers which are coupled in series, and the depositing device is arranged in the vacuum chamber which is located in the middle among the three vacuum chambers.

33. The method of claim 30, wherein the depositing device is a resistance heated type.

34. The method of claim 30, wherein the transfer layer formed on the donor substrate is made of a monomer organic light emitting material.

35. The method of claim 30, further comprising,
a thickness measuring means measuring thickness of the transfer layer formed by the depositing device; and
a thickness control means receiving information from the thickness measuring means to control thickness of the transfer layer formed by the depositing device.

36. The method of claim 30, wherein the depositing device is fixed in the vacuum chamber, and the transfer layer is formed on the donor substrate which continuously moves.

37. The method of claim 30, wherein the depositing device is fixed in the vacuum chamber, and the donor substrate stops to form the transfer layer and then moves forward to pass through the vacuum chamber.

38. The method of claim 30, wherein the depositing device performs a reciprocating motion in the vacuum chamber, and the transfer layer is formed on the donor substrate which continuously moves.

39. The method of claim 30, wherein the depositing device performs a reciprocating motion in the vacuum chamber, and the donor substrate stops to form the transfer layer and then moves forward to pass through the vacuum chamber.

40. The method of claim 30, wherein the donor substrate is a flexible donor substrate.

41. The method of claim 30, wherein the deposition process in the vacuum chamber is performed in vacuum of less than 10⁻⁴ torr.
